(19) United States
(12) Patent Application Publication
(10) Pub. No.: US 2014/0133548 A1
(43) Pub. Date: May 15, 2014

(54) METHOD, APPARATUS AND COMPUTER PROGRAM PRODUCTS FOR DETECTING BOUNDARIES OF VIDEO SEGMENTS

(71) Applicants: Sujeet Mate, Tampere (FI); Igor D. Curcio, Tampere (FI); Kostadin Dabov, Tampere (FI)

(72) Inventors: Sujeet Mate, Tampere (FI); Igor D. Curcio, Tampere (FI); Kostadin Dabov, Tampere (FI)

(73) Assignee: Nokia Corporation, Espoo (FI)

(21) Appl. No.: 14/127,968

(22) PCT Filed: Jun. 30, 2011
(86) PCT No.: PCT/FI2011/050622

§ 371 Date: Dec. 19, 2013

(51) Int. Cl. H04N 19/142; H04N 19/114

(52) U.S. Cl. CPC H04N 19/00163; H04N 19/00054
USPC 375/240.02

(57) ABSTRACT

There is provided a method comprising receiving at least one sample of a sensor data obtained from at least one sensor; obtaining an indicator of a video scene change on the basis of the at least one sample of the sensor data; and providing the indicator in order to change at least one parameter of a video encoding. There is also provided an apparatus comprising a processor, and memory including computer program code. The memory and the computer program code are configured to, with the processor, cause the apparatus to receive at least one sample of a sensor data; obtain an indicator of a video scene change on the basis of the at least one sample of the sensor data; and provide the indicator in order to change at least one parameter of a video encoding.

### TECHNICAL FIELD

The present invention relates to a method to detect boundaries of video segments. The invention also relates to apparatuses adapted to detect of video segments and computer program products comprising program code to detect of video segments. The invention also relates to methods applying the said boundaries for video encoding.

### BACKGROUND INFORMATION

Many video coding schemes (for example Moving Picture Experts Group's standards MPEG 1, MPEG 2, and MPEG 4, the International Telecommunication Union's ITU-T H.263 and H.264 coding standards, etc) utilize correlation between consecutive video frames in order to compress a video signal. When the video scene is predominantly static, then there exist significant amount of correlation and this may enable effective compression. When there appears a change of scene, then the amount of correlation significantly decreases, in general, as the new scene may be completely different. In order to exploit the inter-frame correlation and also to avoid problems at scene changes, the current standard video coding algorithms such as H.264 use intra-coded frames, which are encoded without exploiting correlation with other frames and predicted frames, which exploit correlation with adjacent frames. A group of pictures (GOP) notation is often used to describe a series of frames starting with an intra-coded frame and followed by predicted frames. It is natural to see that a GOP would optimally start after a change of scene in order to allow for good prediction. Therefore, the detection of scene changes has emerged as an important topic in video processing. A closed GOP starts with an intra-coded frame (key frame) and contains one or more predicted frames or frames that contain predicted and intra-coded macroblocks. An open GOP may start with one or more predicted frames (which may be called as leading frames) followed by an intra-coded frame and one or more predicted frames or frames that contain predicted and intra-coded macroblocks.

Camera-enabled handheld electronic devices may be equipped with multiple sensors that can assist different applications and services in contextualizing how the devices are used. Sensor (context) data and streams of such data can be recorded together with the video or image or other modality of recording (e.g. speech). As means of example, the satellite based location (e.g. the Global Positioning System, GPS) can be included as well as other information such as streams of compass, accelerometer, and/or gyroscope readings.

### SUMMARY OF SOME EXAMPLE EMBODIMENTS

The present invention introduces a method, a computer program product and technical equipment implementing the method, by which the detection of video segments containing different scenes may be improved and the above problems may be alleviated. Various aspects of the invention include a method, an apparatus, a server, a client and a computer readable medium comprising a computer program stored therein.

According to some embodiments context sensor data, such as from accelerometers, gyroscopes, and/or compasses, are exploited for detecting e.g. video-scene boundaries (e.g. start and duration) and the boundaries of groups of pictures (GOP) used for video encoding (e.g., in H.264, MPEG 1, MPEG 2, and MPEG 4).

In some embodiments of the invention, the encoding is performed in real time and sensor data is processed in real time (within a predefined delay threshold) together with the video encoding.

In another embodiment of the invention, the encoding is preformed in offline mode. In this case, the context sensor data has been recorded (together with proper timing data such as timestamps) and stored together with the video sequence.

In some embodiments of the invention, the obtained scene boundaries (and GOP boundaries) are communicated to a service that uses this information in order to combine segments from multiple videos into a single composite video such a video remix (or a video summary).

In another embodiment of the invention, the analog/digital gain (adjusted automatically by the camera module) is obtained, e.g. by sampling at fixed or variable rate during video recording and its value is used to detect change of scene and GOP boundaries of the video encoding, which may be due to a sudden change in illumination, and also to affect the quantization parameters of the encoder (e.g. a greater value of the analog/digital gain can result in stronger quantization in order to accommodate for a decrease in picture quality).

In another embodiment of the invention, if shaking or very fast movement is detected with the available sensors, the quantization parameters of the encoders may be modified so that fewer bits are used to encode blurry/shaky images.

According to a first aspect of the present invention there is provided a method comprising:
receiving at least one sample of a sensor data obtained from at least one sensor;
obtaining an indicator of a video scene change on the basis of the at least one sample of the sensor data; and
providing the indicator in order to change at least one parameter of a video encoding.

In some embodiments the video data is encoded and the sensor data is processed in real time.

In some embodiments video data is encoded and stored; and sensor data is stored in connection with the encoded video data.

In some embodiments the acquisition time of the stored sensor data is stored.

In some embodiments the indicator is used to obtain a boundary of a group of pictures.

In some embodiments the sensor data is used to examine a current status of an apparatus, wherein if the current status is different from a previous status of the apparatus, said indicator of a video scene change is obtained.

In some embodiments the sensor data is at least one of:
compass data;
accelerometer data;
gyroscope data;
audio data;
proximity data;
data of a position of the apparatus; and
data indicative of illumination.

According to a second aspect of the present invention there is provided an apparatus comprising:

comprising a processor, memory including computer program code, the memory and the computer program code configured to, with the processor, cause the apparatus to:
receive at least one sample of a sensor data obtained from at least one sensor;
obtain an indicator of a video scene change on the basis of the at least one sample of the sensor data; and
provide the indicator in order to change at least one parameter of a video encoding.

In some embodiments the apparatus may comprise a camera.

According to a third aspect of the present invention there is provided a computer program product comprising program code for:
receiving at least one sample of a sensor data;
obtaining an indicator of a video scene change on the basis of the at least one sample of the sensor data; and
providing the indicator in order to change at least one parameter of a video encoding.

According to a fourth aspect of the present invention there is provided a communication device comprising:
an encoder for encoding video data;
an input adapted to receive at least one sample of a sensor data;
a determinator adapted to obtain an indicator of a video scene change on the basis of the at least one sample of the sensor data; and
an output adapted to provide the indicator in order to change at least one parameter of a video encoding

According to a fifth aspect of the present invention there is provided an apparatus comprising:
means for receiving at least one sample of a sensor data;
means for obtaining an indicator of a video scene change on the basis of the at least one sample of the sensor data;
means for providing the indicator in order to change at least one parameter of a video encoding.

The invention may provide increased bit rate efficiency in encoding without increase in computational complexity. It may also be possible to avoid problems of having predicted frames for which there are no prior frames to get prediction from. Such a situation may arise e.g. in the case when a camera is moving fast. This may mean avoiding obvious visual artifacts (blockiness, etc.). Due to the direct knowledge about the scene change from sensor data, single pass encoding may provide better results than some other methods. This may result in savings in computational complexity as well as time required for encoding the video. Improvements in efficiency may be independent of the encoding video size. Thus, higher relative savings with high resolution content compared to low-resolution may be expected.

### DESCRIPTION OF THE DRAWINGS

In the following, various embodiments of the invention will be described in more detail with reference to the appended drawings, in which

FIG. 1 shows schematically an electronic device employing some embodiments of the invention;

FIG. 2 shows schematically a user equipment suitable for employing some embodiments of the invention;

FIG. 3 further shows schematically electronic devices employing embodiments of the invention connected using wireless and wired network connections;

FIG. 4a shows schematically some details of an apparatus employing embodiments of the invention;

FIG. 4b shows schematically further details of a scene change detection module according to an embodiment of the invention;

FIG. 5 shows an overview of processing steps to implement the invention;

FIG. 6 depicts an example of a picture the user has taken;

FIG. 7 illustrates an example of sensor data and a first derivative of the sensor data;

FIG. 8a depicts an example of a part of a sequence of video frames without the utilization of the scene change detection; and

FIG. 8b depicts an example of a possible effect of the scene change detection to the sequence of video frames of FIG. 8a according to an example embodiment of the present invention.

### DETAILED DESCRIPTION OF SOME EXAMPLE EMBODIMENTS

This invention concerns video encoding schemes for which the following terms are applicable: group of pictures (GOP), key frames, predicted frames, quantization parameter. These include MPEG 2 and MPEG 4 (including H.264).

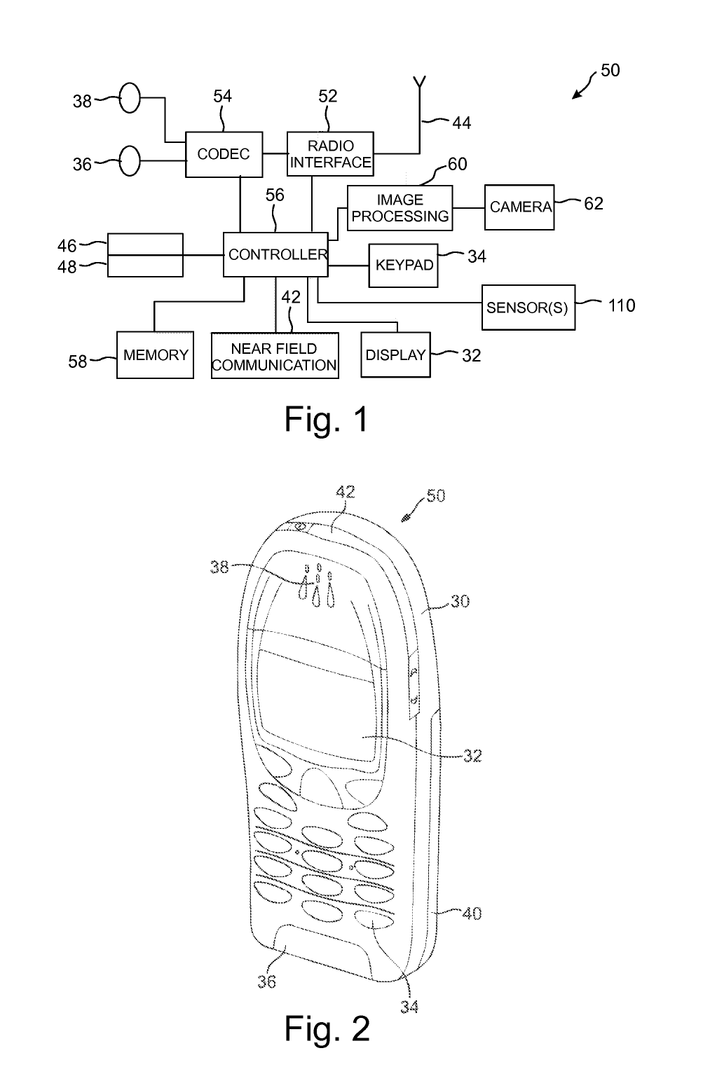

The following describes in further detail suitable apparatuses and possible mechanisms for the detection of scene changes in connection with video capturing and/or playback. In this regard reference is first made to FIG. 1 which shows a schematic block diagram of an exemplary apparatus or electronic device 50, which may incorporate a scene change detection module 100 according to an embodiment of the invention.

The electronic device 50 may for example be a mobile terminal or user equipment of a wireless communication system, a digital camera, a laptop computer etc. However, it would be appreciated that embodiments of the invention may be implemented within any electronic device or apparatus which may contain video processing and/or scene change detection properties.

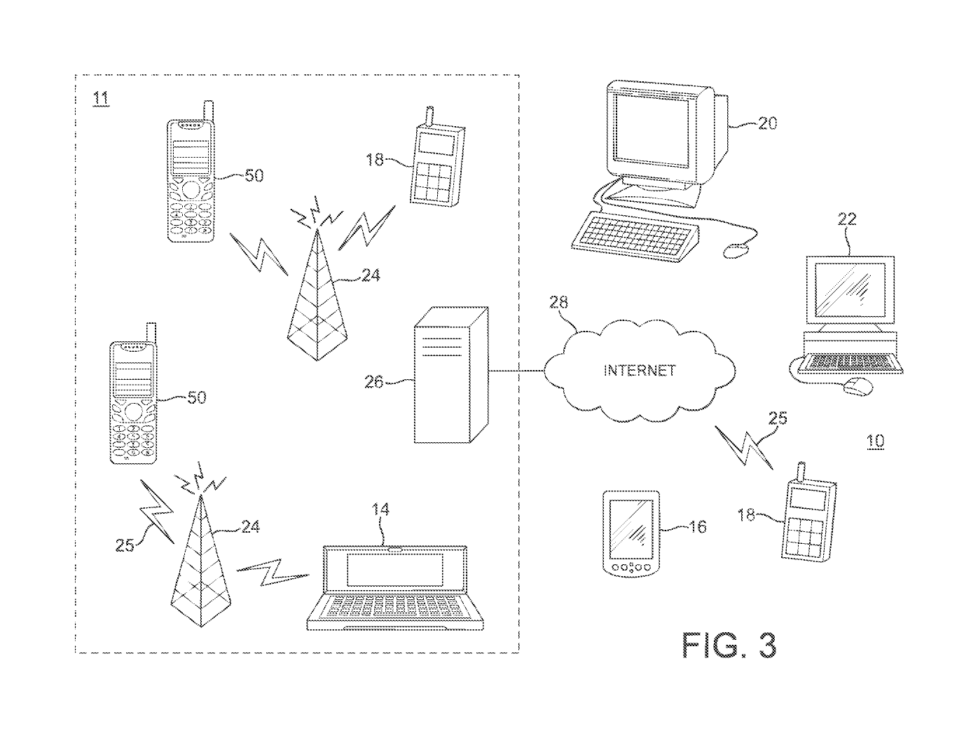

The apparatus 50 may comprise a housing 30 (FIG. 2) for incorporating and protecting the device. The apparatus 50 further may comprise a display 32 in the form of a liquid crystal display. In other embodiments of the invention the display may be any suitable display technology suitable to display an image or video. In some embodiments the display 32 may be a touch-sensitive display meaning that, in addition to be able to display information, the display 32 is also able to sense touches on the display 32 and deliver information regarding the touch, e.g. the location of the touch, the force of the touch etc. to the controller 56. Hence, the touch-sensitive display can also be used as means for inputting information. In an example embodiment the touch-sensitive display 32 may be implemented as a display element and a touch-sensitive element located above the display element.

The apparatus 50 may further comprise a keypad 34. In other embodiments of the invention any suitable data or user interface mechanism may be employed. For example, the user interface may be implemented as a virtual keyboard or data entry system as part of a touch-sensitive display or it may contain speech recognition capabilities. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise a near field communication (NFC) connection 42 for short range communication to other devices, e.g. for distances from a few centimeters to few meters or to tens of meters. In other embodiments the apparatus 50 may further comprise any suitable short range communication solution such as for example a Bluetooth wireless connection, an infrared port or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to a codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system and/or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

The apparatus 50 may also comprise one or more sensors 110 to detect the state of the apparatus (e.g. whether the apparatus is steady or shaking or turning or otherwise moving), conditions of the environment etc.

In some embodiments of the invention, the apparatus 50 comprises a camera 62 capable of recording or detecting individual frames or images which are then passed to an image processing circuitry 60 or controller 56 for processing. In other embodiments of the invention, the apparatus may receive the image data from another device prior to transmission and/or storage. In other embodiments of the invention, the apparatus 50 may receive either wirelessly or by a wired connection the image for coding/decoding.

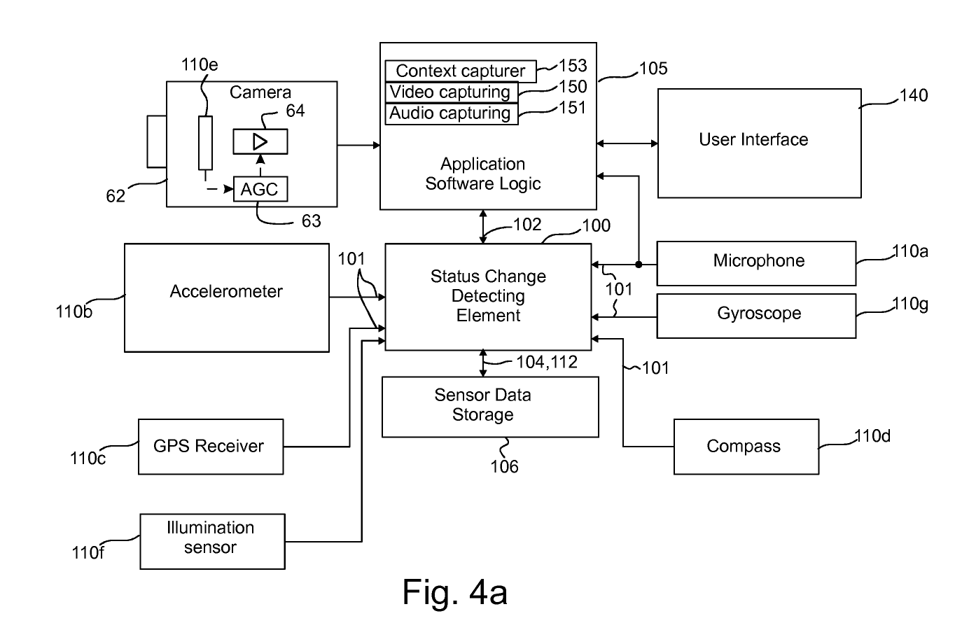

With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as the global system for mobile communications (GSM) network, 3^{rd} generation (3G) network, 3.5^{th} generation (3.5G) network, 4^{th} generation (4G) network, universal mobile telecommunications system (UMTS), code division multiple access (CDMA) network etc), a wireless local area network (WLAN) such as defined by any of the Institute of Electrical and Electronic Engineers (IEEE) 802.x standards, a bluetooth personal area network, an ethernet local area network, a token ring local area network, a wide area network, and the Internet.

The system 10 may include both wired and wireless communication devices or apparatus 50 suitable for implementing embodiments of the invention.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

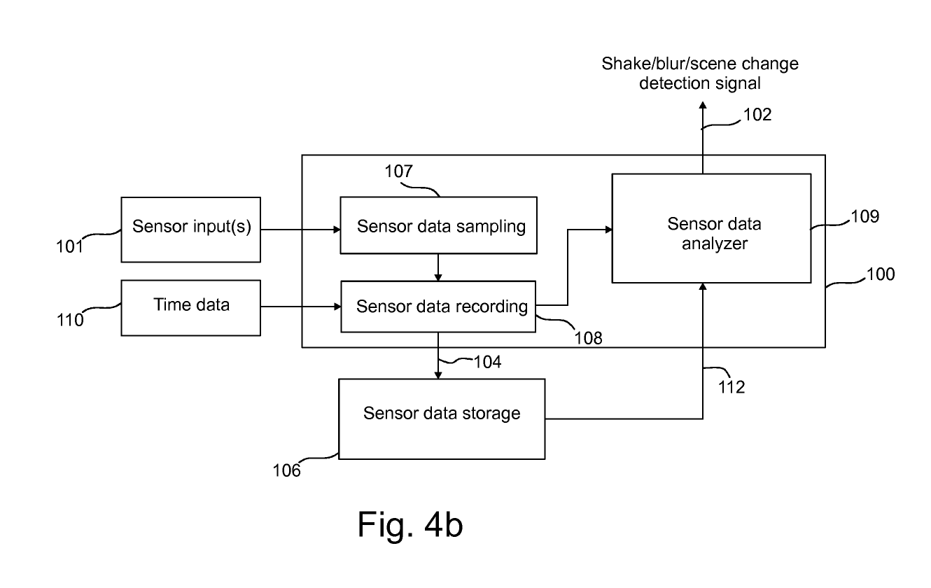

In FIG. 4a some further details of an example embodiment of the apparatus 50 are depicted. The scene change detection module 100 may comprise one or more sensor inputs 101 for inputting sensor data from one or more sensors 110a-110e. The sensor data may be in the form of electrical signals, for example as analog or digital signals. The scene change detection module 100 may also comprise a video interface 102 for communicating with a video encoding application. The video interface 102 can be used, for example, to input data regarding a detection of a status change of the camera (e.g. scene change, shaky, blurry etc.) and timing data of the detected status change of the camera.

The apparatus 50 may also comprise a sensor data recording element 106 which stores the sensor data e.g. to the memory 58. The sensor data may be received and processed by the sensor data recording element 106 directly from the sensors or the sensor data may first be received by the status change detecting element 100 and then provided to the sensor data recording element 106 e.g. via the interface 104. The scene change detecting element 100 may also be able to retrieve recorded sensor data from the memory 58 e.g. via the sensor data recording element 106.

The application software logic 105 may comprise a video capturing application 150 which may have been started in the apparatus so that the user can capture videos. The application software logic 105 may also comprise, as a part of the video capturing application or as a separate audio capturing application 151, an audio recording application 151 to record audio signals captured e.g. by the microphone 36 to the memory 58. As a generalization, the application software logic 105 may comprise one or more media capturing applications 150, 151 so that the user can capture media clips. It is also possible that the application software logic 105 is capable of simultaneously running more than one media capturing applications 150, 151. For example, the audio capturing application 151 may provide audio capturing when the user is recording a video.

In FIG. 4b some further details of an example embodiment of the scene change detection element 100 are depicted. It may comprise a sensor data sampler 107, a sensor data recorder 108 and a sensor data analyzer 109. The sensor data sampler 107 may comprise an analog-to-digital converter (ADC) and/or other means suitable for converting the sensor data to a digital form. The sensor data sampler 107 receives and samples the sensor data if the sensor data is not already in a form suitable for analyses and recording, and provides the samples of the sensor data to the sensor data recorder 108 for recording (storing) 104 the sensor data into a sensor data memory 106. The sensor data memory 106 may be implemented in the memory 58 of the apparatus or it may be another memory accessible by the sensor data sampler and recorder and suitable for recording sensor data. The sensor data recorder 108 may also receive time data 111 from e.g. a system clock of the apparatus 50 or from another source such as a GPS receiver. The time data 111 may be stored in connection with the recorded samples to indicate the time instances the recorded sensor data samples were captured. The sensor data recorder 108 (or the sensor data sampler 107) may also provide the sampled sensor data to the sensor data analyzer 109 which analyses the sensor data to detect possible scene changes. The sampled sensor data provided to the sensor data analyzer 109 may also comprise the time data 111 relating to the samples.

The sensor data sampler 107, a sensor data recorder 108 and a sensor data analyzer 109 can be implemented, for example, as a dedicated circuitry or as a program code of the controller 56 or a combination of these.

In the following an example of a method according to the present invention will be described in more detail. It is assumed that the method is implemented in the apparatus 50 but the invention may also be implemented in a combination of devices as will be described later in this application. In this embodiment it is assumed that the scene change detection is performed in real time. The term real time may not mean the same instance a sensor provides a sensor data signal but it may include delays which are evident during the operation of the apparatus 50. For example, there may be a short delay before the sensor data is received by the sensor data sampler 107, the sampling of the sensor data takes some time, and the recording of the sensor data causes some delay to the sensor data processing. However, in practical implementations the delays in the sensor data processing chain are so short that the processing can be thought to occur in real time.

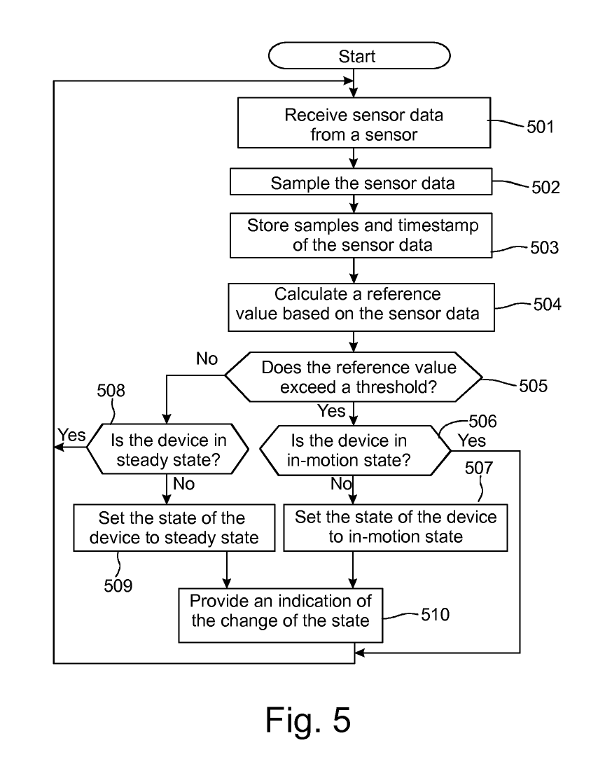

The sensor data 101 can come from one or more data sources 36, 63, 110a-110f. This is illustrated as the block 501 in FIG. 5. For example, the input data can be audio data 110a represented by signals from e.g. a microphone 36, visual data represented by signals captured by one or more image sensors 110e, data from an illumination sensor 110f, data from an automatic gain controller (AGC) 63 of the apparatus 50, location data determined by e.g. a positioning equipment such as a receiver 110c of the global positioning system (GPS), data relating to the movements of the device and captured e.g. by a gyroscope 110g, an accelerometer 110b and/or a compass 110d, or the input data can be in another form of data. The input data may also be a combination of different kinds of sensor data.

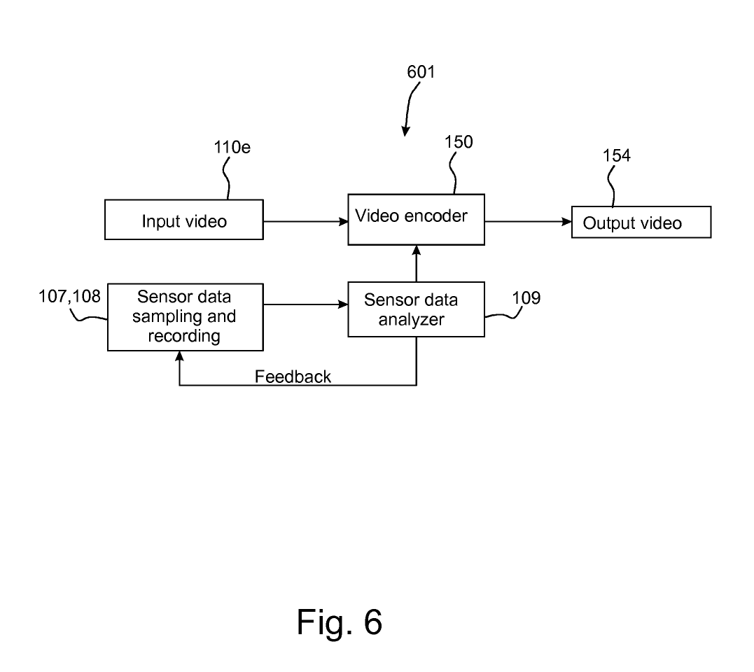

FIG. 6 illustrates one possible scheme of implementing the sensor assisted video encoding. As seen from the figure, sensor data from suitable individual sensors like gyroscope 110g, accelerometer 110b, compass 110d, etc. or a combination of these sensors may be sampled (block 502), recorded and time-stamped (block 503) synchronously with the raw video frames captured from the image sensor 110e. The sensor data may be sampled at the same, at higher or at lower rate compared to the raw video frame capture rate. The sensor data analyzer 109 uses the sensor data to detect scene changes. In order to achieve this, the accelerometer 110b, the gyroscope 110g, and the compass 110d readings as well as their variations in time are analysed (blocks 504, 505). In order to explain better the implementation, two states of the camera 62 are defined. The first camera state is a steady camera state, in which the camera 62 is subject to relatively insignificant translational or rotational movements. The second camera state is a in-motion camera state, in which state the camera is subject to larger rotational and/or translational movements compared to the steady state. A scene change may be detected at least in two cases:
the instance when the camera 62 goes in the in-motion state after being in the steady state,
the instance when the camera 62 goes in the steady state after being in the in-motion state.

A scene change may be also detected at the instance when the scene illumination change is detected.

In some other embodiments there may also be other states than the steady state and the in-motion state. For example, the may be a slow-motion state in which the camera is not static but is slowly moving in steady state in one or more directions. The user of the camera may e.g. rotate the camera in the horizontal direction (panning the camera).

The in-motion state may be detected by using the available sensors (e.g. the accelerometer 110b, the gyroscope 110g, the compass 110d). The angular velocity (around one or more axes) measured by the gyroscope 110g can be directly compared with a predefined threshold for each of the one or more measurement axes to detect if the rotational motion corresponds to the in-motion state. For the accelerometer 110b, changes in sensor data from the accelerometer 110b (in one or more axes) are indicative of either changes in the static acceleration component (due to gravitation) or changes in translational acceleration. To cover these two distinct cases, changes in the sensor data from the accelerometer 110b are tracked e.g. by computing the first discrete derivative of the acceleration as a function of time. The first discrete derivative can be computed as the difference between sensor data from the accelerometer 110b at two different instances of time divided by the difference in time of these sensor data. The time difference can be determined e.g. by using the timestamps which may have been stored with the sensor data. The discrete derivative of the accelerometer data may then be compared (block 505) with a predefined threshold to detect whether the camera is in the in-motion state or not.

The changes in compass orientation can also be tracked in a similar manner to assist in the detection of rotational motion. That is, the discrete derivative of the compass orientation is compared to a predefined threshold; if it exceeds the threshold, then in-motion camera state is indicated. On the other hand, the steady camera state is indicated by the lack of rotational or translational motion (detected e.g. as described above).

In some example embodiments the determination whether a state of the apparatus has changed may be performed by using the sensor data to obtain an indication and using the indication to determine the state of the apparatus. In some embodiments the determination may comprise comparing the indication with a first threshold value. If the indication exceeds the first threshold value it may be determined that the apparatus is in a second state, e.g. in the in-motion state. The time of the detected change of the status may also be stored e.g. as a time stamp or by means of another timing information. In some other embodiments the determination whether a state of the apparatus has changed may be performed by examining if the indication is between the first threshold value and a second threshold value or if the indication is not between the first threshold value and the second threshold value. Then, if the indication is between the first and second threshold values it may be determined that the apparatus is in the second state, or if the indication is not between the first and second threshold values it may be determined that the apparatus is in the first state.

In some example embodiments the sensor data analyzer 109 receives sensor data from the sensor data recorder 108 together with the time data of the sensor data (timestamps). When the sensor data analyzer 109 is comparing the newest sensor data from one of the sensors the sensor data analyzer 109 retrieves 112 one or more of the previously recorded sensor data values of the same sensor from the sensor data storage 106 and uses these data to calculate the difference of the sensor data, a first discrete derivative of the sensor data, a second discrete derivative of the sensor data or another data which may help the sensor data analyzer 109 determine the state of the camera.

When the sensor data analyzer 109 has determined the state of the camera, the sensor data analyzer 109 provides a signal 102 indicative of the state (block 510) e.g. to the application software logic 105 which may provide the data to the video capturing application 150 which performs encoding of the video data and may output the encoded video data. It should be noted here that the video capturing application 150 (e.g. an encoder) may also be implemented as a hardware or a mixture of software and hardware. the video capturing application 150 may then use the status of the camera to determine whether a new group of pictures (GOP) should be started or the current GOP could continue. In other words, the video capturing application 150 may insert GOP boundaries at detected scene changes and insert keyframes (e.g. Intra frames).

The sensor data analyzer 109 may also provide the change of the state of the camera detection signal as a feedback to the sensor data recorder 108 so that the sensor data recorder 108 can insert an indication of a scene change to the sensor data.

In some embodiments of the invention, the sensor data analyzer 109 also assists the context-capture engine 153 to optimize the sensors that will be used as well as their operating parameters (like sampling rate, switched on/off), etc. The sensor data sampling rate may also be adapted based on the camera motion information derived from sensor data sampling. For example, if sensor data from the accelerometer 110b indicates that the camera 62 is installed on a tripod, the sampling rate may be reduced for that sensor (i.e. the accelerometer 110b in this example) while maintaining full sampling rate for e.g. the compass 110d to determine possible panning of the camera. The determination that the camera 62 is installed on a tripod may be based on the amount of variation of successive sensor data values from the accelerometer 110b. If the variation between successive samples is lower than a threshold it may be determined that the camera is in a steady state in the vertical direction.

The present invention may also be implemented off-line. The operation is quite similar to the real time case except that the sensor data analyzer inference data may also be stored together with the sensor data to enable offline processing of the captured video sequence. For example, the apparatus 50 may capture video data and encode it into sequence of encoded video frames, or the apparatus 50 may store the captured video without encoding it first. The video frames are attached with timestamp, or the timing data is stored separate from the video frames but so that the timing of the video frames can be deduced on the basis of the timing data. The apparatus 50 also stores sensor data and provides timestamps to the samples of sensor data. Further, the data from the sensor data analyzer (e.g. the state change detect signal) may also be stored with the sensor data (and time stamped, if necessary). When the apparatus retrieves the captured video from the memory, it reads the encoded video data and the scene change data and begins a new GOP at the moments when the scene change has been detected. If the video data was stored in unencoded form, the apparatus 50 reads the video data and encodes it. On the time instances when a scene change has been detected the apparatus 50 (or the encoder of the apparatus 50 or of another apparatus) inserts an I-frame and begins to encode a new GOP.

In some embodiments of the invention, the detected camera motion is used to change the quantization parameter of the encoder. This is done in order to reduce the bit rate for frames that would otherwise appear blurry and/or with shake. In this embodiment the encoder may not insert a keyframe or I-frame to the video stream but only change the quantization parameter, or the encoder insert a keyframe or I-frame to the video stream and changes the quantization parameter

In some embodiments of the invention, the analog/digital gain is used to detect scene changes (due to sudden changes in illumination) and GOP boundaries of the video encoding as well as affect the quantization parameters of the encoder. Sudden changes in illumination may result in sudden changes of the video pixel intensities, which can only partially be compensated with varying the analog/digital gain. In this scenario, even if there is no change of scene (i.e., no rotation or translation), it may be useful to insert a keyframe or start a new GOP at the time of illumination change—since the predicted pixel intensities may otherwise be incorrect (even though the predicted motion would be correct). In this implementation, the analog/digital gain(s) read at some variable or fixed sampling rate, which is/are automatically adjusted by the camera throughout the video recording. Sudden changes in illumination can be detect by checking if the change of the analog/digital gain exceeds a certain predefined threshold. The change of illumination may be computed as the first discrete derivative of the analog/digital gain as the function of time (i.e. the difference between the analog/digital gain values divided by the difference in their time-stamps).

The changes in angle of view of the apparatus may also be used to determine whether the state of the apparatus has changed so that a scene has occurred. The angle of view and/or the change in the angle of view may be measured by the compass, by an accelerometer or by some other appropriate means.

In addition to detecting scene changes in the case of sudden illumination changes, in this implementation, the quantization parameters of the encoder may also be affected by illumination changes. In the case of sudden decrease of illumination, evidenced by increase in the analog/digital gain (as described above), the level of noise can significantly increase. To compensate for an increased level of noise, the quantization parameters are increased, which also leads to reduced bit rate of the encoded video stream.

The implementation for sensor assisted video encoding for generating a single output video that consists of one or more segments from multiple videos is very similar to the case of off-line video encoding. The sensor data for each individual segment that is selected for inclusion in the composite video is analyzed by the sensor data analyzer 109 to determine scene changes within the individual video segment; this input is provided to the encoder that is re-encoding the video segment. As means of example, the detected scene changes (and GOP boundaries) can be used to assist in selecting view switches.

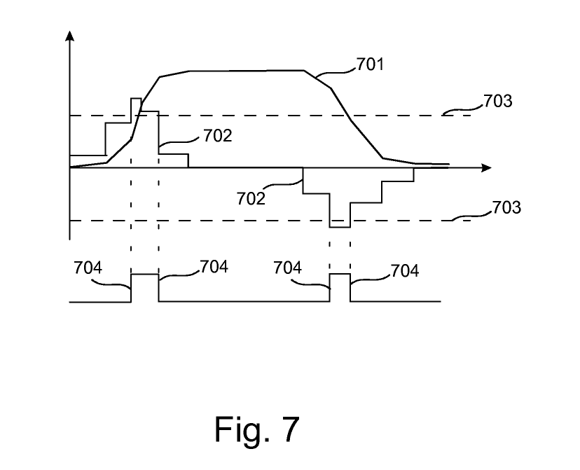

FIG. 7 illustrates an example of sensor data (curve 701 in FIG. 7) and a first derivative of the sensor data (curve 702 in FIG. 7). The sensor data may have been generated by any of the sensors capable of producing significantly continuous data. However, some sensors, such as the GPS receiver 110c, may produce discrete numerical values rather than a continuous analog signal. FIG. 7 also illustrates an example of a threshold 703 with which the sensor data analyzer 109 may use to compare with the first derivative of the sensor data. If the absolute value of the first derivative exceeds the threshold the sensor data analyzer 109 generates a scene change detection signal 704.

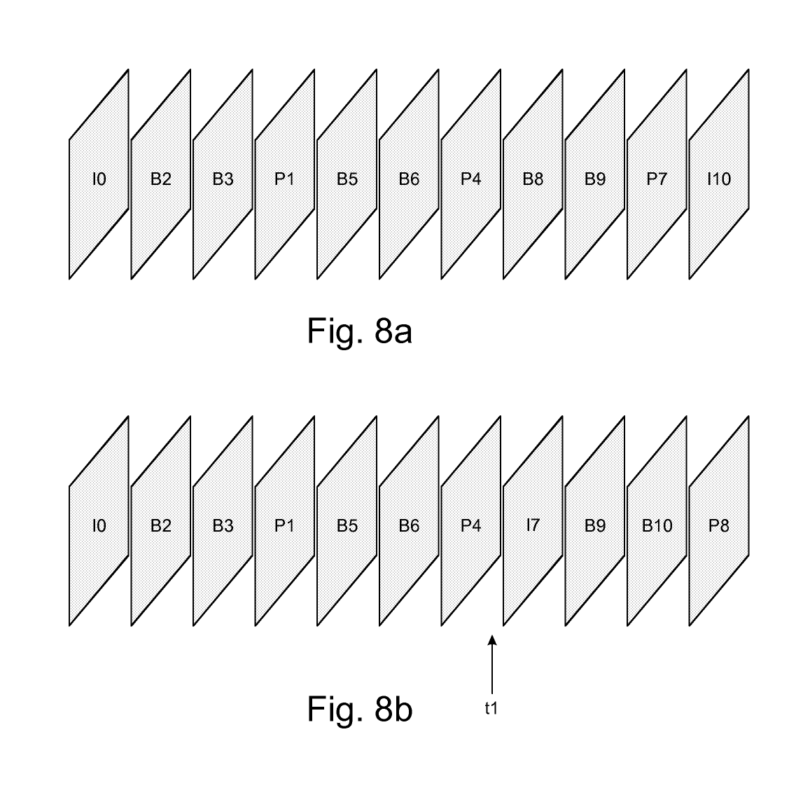

FIG. 8a depicts an example of a part of a sequence of video frames without the utilization of the scene change detection and FIG. 8b depicts an example of a possible effect of the scene change detection to the sequence of video frames of FIG. 8a according to the present invention. The example sequence starts with an I-frame I0 (Intra-predicted frame) and it is followed by sequences of two B-frames (bi-directionally predicted frames) and one P-frame (forward predicted frame). The sequence with one 1-frame followed by one or more predicted frames can be called as a group of pictures (GOP), as was already mentioned in this application. In the example of FIG. 8a there are two GOPs. The video frames in FIGS. 8a and 8b are depicted in output/display order and the numbers in the frames depict the encoding/decoding order of the video frames. The intra frames I0, I10 are encoded without referring to other video frames, the video frame P1 is predicted from the video frame I0, the video frames B2 and B3 are predicted from the video frames I0 and P1, the video frame P4 is predicted from the video frame P1, the video frames B5 and B6 are predicted from the video frames P1 and P4, etc.

In FIG. 8b it is assumed that the scene change detection signal is received by the encoder at the moment t1. Thus, the encoder re-encodes (if necessary) the frames at the scene change. In other words, the encoder may decide to replace the predicted frame which has the same timestamp than the timestamp of the scene change signal or, if the video frame with the same timestamp does not exist, the timestamp which is close to the timestamp of the scene change signal. In this example the bi-directionally predicted video frame B8 of FIG. 8a is replaced with the intra frame I7. The encoder encodes the intra frame and inserts it into the sequence of video frames thus beginning a new GOP.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The invention may also be provided as an internet service wherein the apparatus may send a media clip, information on the selected tags and sensor data to the service in which the context model adaptation may take place. The internet service may also provide the context recognizer operations wherein the media clip and the sensor data is transmitted to the service, the service send one or more proposals of the context which are shown by the apparatus to the user, and the user may then select one or more tags. Information on the selection is transmitted to the service which may then determine which context model may need adaptation, and if such need exists, the service may adapt the context model.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

In the following some examples will be provided.

1. A method comprising:
receiving at least one sample of a sensor data obtained from at least one sensor;
obtaining an indicator of a video scene change on the basis of the at least one sample of the sensor data; and
providing the indicator in order to change at least one parameter of a video encoding.
   2. A method according to the example 1 further comprising encoding video data and processing the sensor data in real time.
   3. A method according to the example 1, further comprising encoding video data, storing the encoded video data; and storing the sensor data in connection with the encoded video data.
   4. A method according to the example 3, comprising storing the acquisition time of the stored sensor data.
   5. A method according to any of the examples 1 to 4, comprising using the indicator to obtain a boundary of a group of pictures.
   6. A method according to the example 5, comprising communicating information on the boundary to a service for combining segments from multiple videos into a single composite video by said service.
   7. A method according to any of the examples 1 to 6 comprising using the sensor data to examine a current status of an apparatus, wherein if the current status is different from a previous status of the apparatus, obtaining said indicator of a video scene change.
   8. A method according to any of the examples 1 to 7 comprising measuring an angular velocity of the apparatus; comparing the measured angular velocity with a first threshold; and on the basis of the comparing determining whether the status of the apparatus has changed.
   9. A method according to any of the examples 1 to 8 comprising using a compass data as said sensor data; examining the sensor data to detect changes in the compass orientation; comparing the changes in the compass orientation with a second threshold; and on the basis of the comparing determining whether the status of the apparatus has changed.
   10. A method according to any of the examples 1 to 9 comprising forming a discrete derivative of the sensor data to detect changes in a status of an apparatus.
   11. A method according to any of the examples 1 to 10 comprising using of an angle of view of an apparatus to determine whether the status of the apparatus has changed.
   12. A method according to any of the examples 1 to 11, comprising using gain values of an image sensor as the sensor data during video encoding; and using the gain values to obtain the indicator.
   13. A method according to the example 12, comprising using the gain values for controlling quantization parameters of the video encoding.
   14. A method according to the example 13, comprising increasing a quantization parameter of the video encoding, if the gain value indicates a decrease in illumination.
   15. A method according to any of the examples 12 to 14, comprising using the gain values for controlling starting a new group of pictures of the video encoding.
   16. A method according to any of the examples 1 to 15 comprising inserting a keyframe into an encoded video stream, when the indicator has been detected.
   17. A method according to the example 16, wherein the keyframe is an intra coded frame.
   18. A method according to any of the examples 1 to 17 comprising optimizing the operation of the at least one sensor on the basis of the indicator.
   19. A method according to any of the examples 1 to 18, wherein the sensor data is at least one of:
compass data;
accelerometer data;
gyroscope data;
audio data;
proximity data;
data of a position of an apparatus; and
data indicative of illumination.
   20. An apparatus comprising a processor, memory including computer program code, the memory and the computer program code configured to, with the processor, cause the apparatus to:
receive at least one sample of a sensor data obtained from at least one sensor;
obtain an indicator of a video scene change on the basis of the at least one sample of the sensor data; and
provide the indicator in order to change at least one parameter of a video encoding.
   21. An apparatus according to the example 20 further comprising computer program code configured to, with the processor, cause the apparatus to encode video data and processing the sensor data in real time.
   22. An apparatus according to the example 20, further comprising computer program code configured to, with the processor, cause the apparatus to encode video data, storing the encoded video data; and to store the sensor data in connection with the encoded video data.
   23. An apparatus according to the example 22, comprising computer program code configured to, with the processor, cause the apparatus to store the acquisition time of the stored sensor data.
   24. An apparatus according to any of the examples 20 to 23, comprising computer program code configured to, with the processor, cause the apparatus to use the indicator to obtain a boundary of a group of pictures.
   25. An apparatus according to the example 24, comprising computer program code configured to, with the processor, cause the apparatus to communicate information on the boundary to a service for combining segments from multiple videos into a single composite video by said service.
   26. An apparatus according to any of the examples 20 to 25 comprising computer program code configured to, with the processor, cause the apparatus to use the sensor data to examine a current status of an apparatus, wherein if the current status is different from a previous status of the apparatus, to obtain said indicator of a video scene change.
   27. An apparatus according to any of the examples 20 to 26 comprising computer program code configured to, with the processor, cause the apparatus to measure an angular velocity of the apparatus; to compare the measured angular velocity with a first threshold; and on the basis of the comparison to determine whether the status of the apparatus has changed.
   28. An apparatus according to any of the examples 20 to 27 comprising computer program code configured to, with the processor, cause the apparatus to use a compass data as said sensor data; to examine the sensor data to detect changes in the compass orientation; to compare the changes in the compass orientation with a second threshold; and on the basis of the comparison to determine whether the status of the apparatus has changed.
   29. An apparatus according to any of the examples 20 to 28 comprising computer program code configured to, with the processor, cause the apparatus to form a discrete derivative of the sensor data to detect changes in a status of an apparatus.
   30. An apparatus according to any of the examples 20 to 29 comprising computer program code configured to, with the processor, cause the apparatus to use of an angle of view of an apparatus to determine whether the status of the apparatus has changed.
   31. An apparatus according to any of the examples 20 to 30, comprising computer program code configured to, with the processor, cause the apparatus to use gain values of an image sensor as the sensor data during video encoding; and to use the gain values to obtain the indicator.
   32. An apparatus according to the example 31, comprising computer program code configured to, with the processor, cause the apparatus to use the gain values for controlling quantization parameters of the video encoding.
   33. An apparatus according to the example 32, comprising computer program code configured to, with the processor, cause the apparatus to increase a quantization parameter of the video encoding, if the gain value indicates a decrease in illumination.
   34. An apparatus according to any of the examples 31 to 33, comprising computer program code configured to, with the processor, cause the apparatus to use the gain values for controlling starting a new group of pictures of the video encoding.
   35. An apparatus according to any of the examples 20 to 34 comprising computer program code configured to, with the processor, cause the apparatus to insert a keyframe into an encoded video stream, when the indicator has been detected.
   36. An apparatus according to the example 35, wherein the keyframe is an intra coded frame.
   37. An apparatus according to any of the examples 20 to 36 comprising computer program code configured to, with the processor, cause the apparatus to optimize the operation of the at least one sensor on the basis of the indicator.
   38. An apparatus according to any of the examples 20 to 37, wherein the sensor data is at least one of:
compass data;
accelerometer data;
gyroscope data;
audio data;
proximity data;
data of a position of an apparatus; and
data indicative of illumination.
   39. An apparatus according to any of the examples 20 to 38 comprising a camera.
   40. A computer program product comprising program code for:
receiving at least one sample of a sensor data;
obtaining an indicator of a video scene change on the basis of the at least one sample of the sensor data; and
providing the indicator in order to change at least one parameter of a video encoding.
   41. A computer program product according to the example 40 further comprising computer program code for encoding video data and for processing the sensor data in real time.
   42. A computer program product according to the example 40, further comprising computer program code for encoding video data, for storing the encoded video data; and for storing the sensor data in connection with the encoded video data.
   43. A computer program product according to the example 42, comprising computer program code for storing the acquisition time of the stored sensor data.
   44. A computer program product according to any of the examples 40 to 43, comprising computer program code for using the indicator to obtain a boundary of a group of pictures.
   45. A computer program product according to the example 44, comprising computer program code for communicating information on the boundary to a service for combining segments from multiple videos into a single composite video by said service.
   46. A computer program product according to any of the examples 40 to 45 comprising computer program code for using the sensor data to examine a current status of an apparatus, and for obtaining said indicator of a video scene change, if the current status is different from a previous status of the apparatus.
   47. A computer program product according to any of the examples 40 to 46 comprising computer program code for measuring an angular velocity of the apparatus; for comparing the measured angular velocity with a first threshold; and for determining on the basis of the comparison whether the status of the apparatus has changed.
   48. A computer program product according to any of the examples 40 to 47 comprising computer program code for using a compass data as said sensor data; for examining the sensor data to detect changes in the compass orientation; for comparing the changes in the compass orientation with a second threshold; and for determining on the basis of the comparison whether the status of the apparatus has changed.
   49. A computer program product according to any of the examples 40 to 48 comprising computer program code for forming a discrete derivative of the sensor data to detect changes in a status of an apparatus.
   50. A computer program product according to any of the examples 40 to 49 comprising computer program code for using of an angle of view of an apparatus to determine whether the status of the apparatus has changed.
   51. A computer program product according to any of the examples 40 to 50, comprising computer program code for using gain values of an image sensor as the sensor data during video encoding; and to use the gain values to obtain the indicator.
   52. A computer program product according to the example 51, comprising computer program code for using the gain values for controlling quantization parameters of the video encoding.
   53. A computer program product according to the example 52, comprising computer program code for increasing a quantization parameter of the video encoding, if the gain value indicates a decrease in illumination.
   54. A computer program product according to any of the examples 51 to 53, comprising computer program code for using the gain values for controlling starting a new group of pictures of the video encoding.
   55. A computer program product according to any of the examples 40 to 54 comprising computer program code for inserting a keyframe into an encoded video stream, when the indicator has been detected.
   56. A computer program product according to the example 55, wherein the keyframe is an intra coded frame.
   57. A computer program product according to any of the examples 40 to 56 comprising computer program code for optimizing the operation of the at least one sensor on the basis of the indicator.
   58. A computer program product according to any of the examples 40 to 57, wherein the sensor data is at least one of:
compass data;
accelerometer data;
gyroscope data;
audio data;
proximity data;
data of a position of an apparatus; and
data indicative of illumination.
   59. A communication device comprising:
an encoder for encoding video data;
an input adapted to receive at least one sample of a sensor data;
a determinator adapted to obtain an indicator of a video scene change on the basis of the at least one sample of the sensor data; and
an output adapted to provide the indicator in order to change at least one parameter of a video encoding
   60. An apparatus comprising:
means for receiving at least one sample of a sensor data;
means for obtaining an indicator of a video scene change on the basis of the at least one sample of the sensor data;
means for providing the indicator in order to change at least one parameter of a video encoding.
   61. An apparatus according to the example 60 further comprising means for encoding video data and processing the sensor data in real time.
   62. An apparatus according to the example 60, further comprising means for encoding video data, means for storing the encoded video data; and means for storing the sensor data in connection with the encoded video data.
   63. An apparatus according to the example 62, comprising means for storing the acquisition time of the stored sensor data.
   64. An apparatus according to any of the examples 60 to 63, comprising means for using the indicator to obtain a boundary of a group of pictures.
   65. An apparatus according to the example 64, comprising means for communicating information on the boundary to a service for combining segments from multiple videos into a single composite video by said service.
   66. An apparatus according to any of the examples 60 to 65 comprising means for using the sensor data to examine a current status of an apparatus; and means for obtaining said indicator of a video scene change, if the current status is different from a previous status of the apparatus.
   67. An apparatus according to any of the examples 60 to 66 comprising means for measuring an angular velocity of the apparatus; means for comparing the measured angular velocity with a first threshold; and means for determining on the basis of the comparison whether the status of the apparatus has changed.
   68. An apparatus according to any of the examples 60 to 67 comprising means for using a compass data as said sensor data; means for examining the sensor data to detect changes in the compass orientation; means for comparing the changes in the compass orientation with a second threshold; and means for determining on the basis of the comparison whether the status of the apparatus has changed.
   69. An apparatus according to any of the examples 60 to 68 comprising means for forming a discrete derivative of the sensor data to detect changes in a status of an apparatus.
   70. An apparatus according to any of the examples 60 to 69 comprising means for using of an angle of view of an apparatus to determine whether the status of the apparatus has changed.
   71. An apparatus according to any of the examples 60 to 70, comprising means for using gain values of an image sensor as the sensor data during video encoding; and means for using the gain values to obtain the indicator.
   72. An apparatus according to the example 71, comprising means for using the gain values for controlling quantization parameters of the video encoding.
   73. An apparatus according to the example 72, comprising means for increasing a quantization parameter of the video encoding, if the gain value indicates a decrease in illumination.
   74. An apparatus according to any of the examples 71 to 73, comprising means for using the gain values for controlling starting a new group of pictures of the video encoding.
   75. An apparatus according to any of the examples 60 to 74 comprising means for inserting a keyframe into an encoded video stream, when the indicator has been detected.
   76. An apparatus according to the example 75, wherein the keyframe is an intra coded frame.
   77. An apparatus according to any of the examples 60 to 76 comprising means for optimizing the operation of the at least one sensor on the basis of the indicator.
   78. An apparatus according to any of the examples 60 to 77, wherein the sensor data is at least one of:
compass data;
accelerometer data;
gyroscope data;
audio data;
proximity data;
data of a position of an apparatus; and
data indicative of illumination.

It is obvious that the present invention is not limited solely to the above-presented embodiments, but it can be modified within the scope of the appended claims.

1-78. (canceled)

79. A method comprising:
receiving at least one sample of a sensor data obtained from at least one sensor;
obtaining an indicator of a video scene change on the basis of the at least one sample of the sensor data; and
providing the indicator in order to change at least one parameter of a video encoding.

80. A method according to claim 79 further comprising encoding video data and processing the sensor data in real time.

81. A method according to claim 79, further comprising encoding video data, storing the encoded video data; and storing the sensor data in connection with the encoded video data.

82. A method according to claim 81, comprising storing the acquisition time of the stored sensor data.

83. A method according to claim 79, comprising using the indicator to obtain a boundary of a group of pictures.

84. A method according to claim 83, comprising communicating information on the boundary to a service for combining segments from multiple videos into a single composite video by said service.

85. A method according to claim 79 comprising using the sensor data to examine a current status of an apparatus, wherein if the current status is different from a previous status of the apparatus, obtaining said indicator of a video scene change.

86. A method according to claim 79 comprising measuring an angular velocity of the apparatus; comparing the measured angular velocity with a first threshold; and on the basis of the comparing determining whether the status of the apparatus has changed.

87. A method according to claim 79 comprising using a compass data as said sensor data; examining the sensor data to detect changes in the compass orientation; comparing the changes in the compass orientation with a second threshold; and on the basis of the comparing determining whether the status of the apparatus has changed.

88. An apparatus comprising a processor, memory including computer program code, the memory and the computer program code configured to, with the processor, cause the apparatus to:
receive at least one sample of a sensor data obtained from at least one sensor;
obtain an indicator of a video scene change on the basis of the at least one sample of the sensor data; and
provide the indicator in order to change at least one parameter of a video encoding.

89. An apparatus according to claim 88 further comprising computer program code configured to, with the processor, cause the apparatus to encode video data and to process the sensor data in real time.

90. An apparatus according to claim 88, further comprising computer program code configured to, with the processor, cause the apparatus to encode video data, to store the encoded video data; and to store the sensor data in connection with the encoded video data.

91. An apparatus according to claim 90, comprising computer program code configured to, with the processor, cause the apparatus to store the acquisition time of the stored sensor data.

92. An apparatus according to claim 88, comprising computer program code configured to, with the processor, cause the apparatus to use the indicator to obtain a boundary of a group of pictures.

93. An apparatus according to claim 92, comprising computer program code configured to, with the processor, cause the apparatus to communicate information on the boundary to a service for combining segments from multiple videos into a single composite video by said service.

94. An apparatus according to claim 88 comprising computer program code configured to, with the processor, cause the apparatus to use the sensor data to examine a current status of an apparatus, wherein if the current status is different from a previous status of the apparatus, to obtain said indicator of a video scene change.

95. An apparatus according to claim 88 comprising computer program code configured to, with the processor, cause the apparatus to measure an angular velocity of the apparatus; to compare the measured angular velocity with a first threshold; and on the basis of the comparison to determine whether the status of the apparatus has changed.

96. An apparatus according to claim 88 comprising computer program code configured to, with the processor, cause the apparatus to use a compass data as said sensor data; to examine the sensor data to detect changes in the compass orientation; to compare the changes in the compass orientation with a second threshold; and on the basis of the comparison to determine whether the status of the apparatus has changed.

97. An apparatus according to claim 88 comprising computer program code configured to, with the processor, cause the apparatus to use of an angle of view of an apparatus to determine whether the status of the apparatus has changed.

98. A computer program product stored on a computer readable medium, the computer program comprising program code for:
receiving at least one sample of a sensor data;
obtaining an indicator of a video scene change on the basis of the at least one sample of the sensor data; and
providing the indicator in order to change at least one parameter of a video encoding.
